(19) United States
(12) Patent Application Publication
(10) Pub. No.: US 2022/0018396 A1
(43) Pub. Date: Jan. 20, 2022

(54) SLIDING BEARING AND METHOD FOR PRODUCING A BEARING ELEMENT FOR A SLIDING BEARING

(71) Applicant: Schaeffler Technologies AG & Co. KG, Herzogenaurach (DE)

(72) Inventors: Serge Kursawe, Uttenreuth (DE); Thomas Weitkamp, Spenge (DE); Frank Bolte, Melle (DE); Thomas König, Röttenbach (DE); Nikolay Podgaynyy, Adelsdorf (DE)

(73) Assignee: Schaeffler Technologies AG & Co. KG, Herzogenaurach (DE)

(21) Appl. No.: 17/299,372

(22) PCT Filed: Jun. 3, 2021
(86) PCT No.: PCT/DE2019/100789

§ 371 Date: Jun. 3, 2021

(30) Foreign Application Priority Data
Dec. 5, 2018 (DE) 10 2018 131 022.6

(51) Int. Cl. F16C 33/12; F16C 33/14

(52) U.S. Cl. CPC F16C 33/121; F16C 33/14; F16C 33/125; F16C 2226/40; F16C 2208/32; F16C 2223/60; F16C 2204/80

(57) ABSTRACT

The present disclosure relates to a sliding bearing comprising a first bearing element and a second bearing element. The first bearing element is coated in multiple layers. An inner layer is deposited on a base material of the first bearing element by means of a vapor deposition method. The inner layer has a structure, and an outer layer designed as a PTFE impregnation layer leveling the structure of the inner layer. The second bearing element is formed of PTFE fiber-reinforced plastic or has a PTFE-containing sliding lining.

### CROSS-REFERENCE TO RELATED APPLICATION

The present application is the U.S. national stage application pursuant to 35 U.S.C. § 371 of International Application No. PCT/DE2019/100789, filed 3 Sep. 2019, which application claims priority from German Patent Application DE 10 2018 131 022.6 filed 5 Dec. 2018, which applications are incorporated herein by reference in their entireties.

### BACKGROUND

The present disclosure relates to a sliding bearing, in particular in the form of a pivot bearing. The present disclosure further relates to a method for producing a bearing element for a sliding bearing.

A component with a sliding structure, which, among other things, can be designed as a sliding bearing bushing, as part of a linear guide or as a pivot bearing ring, is disclosed in DE 10 2014 224 310 A1, for example. The sliding structure of the component comprises a base body and a sliding layer arranged at least in sections on the base body. A plastic is provided as the material of the base body. The sliding layer, on the other hand, has an inorganic material. This can be a metallic or non-metallic material, for example titanium, titanium nitride, diamond-like carbon (DLC), silver, gold, chromium, chromium nitride, or tungsten. The sliding structure of the device according to DE 10 2014 224 310 A1 optionally has a fold structure. This fold structure is intended to provide a storage reservoir for a lubricating medium.

From DE 10 2014 107 036 A1 a pivot bearing having a coated titanium sphere is known. The pivot bearing comprises an inner ring which is rotatably arranged within a bushing and which can be provided with a DLC coating. A lubricant in the form of a film can be arranged between the inner ring and the bushing.

DE 10 2008 037 871 A1 describes a sliding element with a multiple layer, which is composed of an inner protective layer and an outer running layer. The protective layer can contain, for example, DLC, Me-DLC, in particular W-DLC, Ti-DLC, or Cr-DLC, silicon nitride, or mixtures of these materials. The protective layer can be located on a structured surface which has a plurality of depressions and elevations. A bonded coating, among other things, is proposed as the running layer that covers the protective layer. According to DE 10 2008 037 871 A1, it is also possible to use a running layer which contains a metal.

WO 2006/093319 A1 describes an arrangement which is intended for use in a compressor and is intended to have sealing and storage properties. One component of this arrangement is provided with a diamond-like coating.

DE 100 61 397 A1 discloses a planetary transmission, the planetary gears of which are mounted on planetary axles in sliding bearings lubricated with liquid or grease. These sliding bearings have hard material bearing surfaces. Ceramic, hard metal, and cold work steel are named as possible hard materials.

From DE 69 330 10 U a pivot bearing which has an outer ring in which a sleeve is floatingly mounted is known. This sleeve is coated with polytetrafluoroethylene (PTFE) on one side, namely on the inside facing away from the outer ring.

Another pivot bearing is disclosed in DE 10 2004 041 084 B4. This pivot bearing has an outer ring divided into two halves, the inner surface of which is adapted to the surface of an inner ring. The two halves of the outer ring are connected to one another by an enclosure. The enclosure can be in the form of a metal ring or wound from a fiber composite material.

From DE 10 2007 053 529 A1 and DE 10 2007 053 528 A1 sliding bearings with removable sliding linings are known.

The object of the present disclosure is to specify a sliding bearing that has been further developed compared to the prior art mentioned, wherein rational, environmentally friendly manufacturing options are provided.

### SUMMARY

Parts of the sliding bearing are a first bearing element, that is coated in multiple layers and a second bearing element. An inner layer is deposited on a base material of the first bearing element by means of a vapor deposition method. The inner layer has a structure, and an outer layer which is designed as a PTFE impregnation layer leveling the structure of the inner layer. The second bearing element is formed of PTFE fiber-reinforced plastic or has a PTFE-containing sliding lining.

The structure of the inner layer of the first bearing element is adapted to the surface structure of the base material of the first bearing element and is, for example, in the form of individual depressions which are spaced apart from one another.

According to the present disclosure, the inner layer is deposited on the base material of the first bearing element with the aid of a vapor deposition method. The term vapor deposition method includes PVD (physical vapor deposition) methods, PACVD (plasma-assisted chemical vapor deposition) methods, PECVD (plasma-enhanced chemical vapor deposition) methods and CVD (chemical vapor deposition) methods. What all these deposition methods have in common is that, in contrast to hard chrome plating, which was mostly used at the time of priority, the layer is deposited on the bearing element without the use of substances containing chromium (VI).

The PTFE impregnation layer is a layer which is formed exclusively, or at least 98%, in particular at least 99%, from polytetrafluoroethylene. The PTFE impregnation layer thus differs from the running layers described in the prior art (DE 10 2008 037 871 A1) in the form of a bonded coating which contains PTFE in a thermoplastic resin.

The inner layer of the first bearing element is present in one possible configuration as a diamond-like amorphous carbon layer, i.e., a DLC (diamond-like carbon) layer. This can be a hydrogen-containing amorphous carbon layer, which is generally designated as a-C:H.

In an example embodiment, the inner layer of the first bearing element of the sliding bearing has, if it is a carbon layer, a metallic and/or non-metallic doping. In general, metal-containing carbon layers are designated as a-C:H:Me. The metal Me is, for example, tungsten, titanium, silicon, or tantalum. With tungsten as the doping element, the designation a-C:H:W results. A coating containing a non-metal, designated as a-C:H:X, where X stands for a non-metal, can also be used.

As an alternative to a doped carbon layer, a hydrogen-free carbon layer, which is generally designated as a-C or ta-C, can also be used as the inner layer of the first bearing element.

With the aid of a vacuum deposition method, in particular a PVD method, a metallic layer can also be deposited on the first bearing element as an alternative to a carbon layer. This can either be a layer made from a single element or an alloy. Examples of elements that can be used in any desired combination to form the inner layer of the coating on the first bearing element are chromium, copper, zinc, and tin. For example, the inner layer is a bronze, brass, or white metal layer.

Configurations can also be implemented in which the inner layer contains hard material in the form of a nitridic, carbidic or oxidic hard material, or is completely formed therefrom and is present as a hard material layer. Examples are TiN, TiCN, Al₂O₃, TiAlN, CrN, and AlCrN. Mixed forms comprising two or more of these materials, optionally with doping(s), are also suitable as the inner layer of the first bearing element.

In an example embodiment, the inner layer is MoN/Cu. In this way, MoN and copper are deposited alternately in thin layers, so that the inner layer is formed by a layer sequence. The PTFE impregnation layer is then formed on top thereof as the outer layer.

All of the above-mentioned components of the inner layer of the multilayer coating of the first bearing element can be combined with one another in any desired way. In all cases, the hardness of the inner layer—regardless of the measuring method used—is far greater than the hardness of the PTFE impregnation layer. The PTFE impregnation layer offers the possibility of absorbing particles that arise during operation of the sliding bearing, in particular particles resulting from abrasion, wherein the structure of the inner layer provides spaces for receiving such particles. Despite possible individual damages to the PTFE impregnation layer, the sliding bearing surface formed by PTFE remains largely intact during operation of the sliding bearing, wherein self-healing effects are also present within the PTFE impregnation layer.

In an example embodiment, the first bearing element is made of metal, for example, made of steel.

In an example embodiment, the second bearing element is reinforced in particular by means of wound PTFE fibers and is made entirely of plastic. In addition to the PTFE fibers, support fibers, in particular made of plastic, metal, glass, carbon, or ceramic, can also be present the preceding can be present alone or in any desired combination with one another.

In an example embodiment, the second bearing element is a metal bearing element provided with the sliding lining. The sliding lining is, for example, glued to the metallic second bearing element and reinforced with PTFE fibers. Textile materials such as woven fabrics, knitted fabrics and the like are generally used as fibers to reinforce the sliding lining. In addition to the PTFE fibers, support fibers, in particular made of another plastic, metal, glass, carbon, or ceramic, can be present. The preceding can be present alone or in any desired combination with one another. In an example embodiment, the sliding lining contains a PTFE fabric in a resin matrix.

In an example embodiment, the sliding lining has a layer of sintered bronze, which is provided with a PTFE layer, so that a metal-polymer composite material is present in the area of the sliding contact.

The first bearing element can be the inner ring or the outer ring of a pivot bearing. In particular, the inner ring and/or the outer ring are made of steel. Thus, the inner ring has the coating, while the outer ring has the sliding lining or is made of plastic reinforced with PTFE fibers. However, an inverse arrangement is also possible.

### BRIEF DESCRIPTION OF THE DRAWINGS

In the following, an exemplary embodiment of the invention is explained in more detail with drawings. In the figures:

FIG. 1 shows, in a schematic sectional representation, a sliding bearing according to the invention,

FIG. 2 shows, in a schematic representation, an enlarged representation of FIG. 1 in the area of the sliding contact,

FIG. 3 shows, in a representation analogous to FIG. 2, the detailed structure of the sliding bearing of the device according to FIG. 1.

### DETAILED DESCRIPTION

Parts that correspond to each other or have basically the same effect are marked with the same reference symbols in all figures.

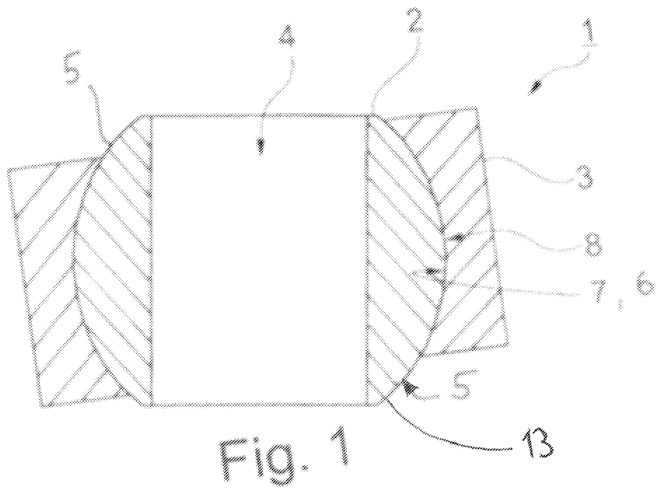

Sliding bearing 1 in FIG. 1, namely a pivot bearing, is formed from first, inner bearing element 2 and second, outer bearing element 3. Bearing element 2 has central opening 4 for connection to a connecting part (not shown). Bearing element 2 has coating 5 comprising inner layer 9 and outer layer 10 (see FIG. 3) on convex outer surface 8. Bearing element 3 has sliding lining 6 on concave inner surface 7.

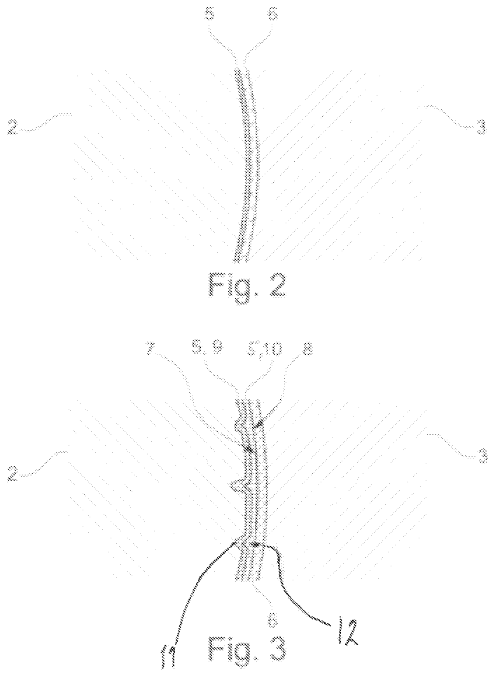

FIG. 2 shows an enlarged section from FIG. 1 in the area of the sliding contact. Bearing element 2 is provided with coating 5 and Bearing element 3 is provided with sliding lining 6, which differ significantly from one another with regard to the hardness thereof. For example, coating 5 comprises inner layer 9 in the form of a hard material layer, whereas sliding lining 6, which is glued into second bearing element 3, contains, for example, a PTFE fabric in a resin matrix.

No chromium VI-containing electrolyte is required to produce sliding bearing 1 according to FIGS. 1 to 3. Rather, inner layer 9 is first deposited on the base material of Bearing element 2 by means of vapor deposition. The base material is designed to be metallic, for example made of steel. Inner layer 9 has a substantially uniform thickness. As a result, the surface of inner layer 9 adapts to the given structure of the base material, which has depressions 11 as structures.

After inner layer 9 has been deposited directly on the surface of the metallic base material of bearing element 2, a PTFE impregnation layer is applied to inner layer 9 as outer layer 10. Unevenness and depressions 11 of inner layer 9 present as structures 11 are leveled by the PTFE impregnation layer, so that a smooth, in the present case spherical, outer surface of bearing element 2 results.

In contrast to bearing element 2 coated in multiple layers, bearing element 3 is provided with sliding lining 6 which is glued on. For example, sliding lining 6 is formed from a PTFE fabric embedded in a resin matrix or from a metal-polymer composite material containing sintered bronze and PTFE. Overall, concave inner surface 7 of bearing element 3 is formed by sliding lining 6. Coating 5 of bearing element 2 forms convex outer surface 8 that contacts inner surface 7.

### LIST OF REFERENCE SYMBOLS

1 Sliding bearing, pivot bearing
2 Bearing element
3 Bearing element
4 Opening
5 Coating of the bearing element 2
6 Sliding lining of the bearing element 3
7 Concave inner surface
8 Convex outer surface
9 Inner layer
10 Outer layer
11 Structure, depression

1-10. (canceled)

11. A sliding bearing, comprising:
a first bearing element including:
a first surface;
a coating including:
a vapor deposition inner layer covering the first surface; and,
an outer layer:
including polytetrafluoroethylene (PTFE); and,
covering the vapor deposition inner layer; and,
a second bearing element including:
a second surface; and,
a layer, including PTFE, glued to the second surface and in contact with the outer layer of the first bearing surface.

12. The sliding bearing of claim 11, wherein the vapor deposition inner layer includes an amorphous carbon.

13. The sliding bearing of claim 12, wherein the amorphous carbon includes at least one doping element.

14. The sliding bearing of claim 12, wherein the amorphous carbon includes metallic and non-metallic doping elements.

15. The sliding bearing of claim 12, wherein the amorphous carbon is free of hydrogen.

16. The sliding bearing of claim 11, wherein the vapor deposition inner layer includes a metal.

17. The sliding bearing of claim 11, wherein the vapor deposition inner layer includes at least one hard material selected from the group consisting of nitridic hard materials, carbidic hard materials, and oxidic hard materials.

18. The sliding bearing of claim 11, wherein the vapor deposition inner layer includes at least one hard material selected from the group consisting of titanium, aluminum, chromium, and molybdenum.

19. The sliding bearing of claim 11, wherein the layer of the second bearing element includes PTFE fiber-reinforced plastic.

20. The sliding bearing of claim 11, wherein the layer of the second bearing element includes:
a PTFE fabric in a resin matrix; or,
a metal-polymer composite material including sintered bronze and PTFE.

21. The sliding bearing of claim 11, wherein:
the first surface includes a first plurality of depressions;
the vapor deposition inner layer conforms to the first surface and includes a second plurality of depressions in contact with the first plurality of depressions; and,
the outer layer fills the second plurality of depressions and forms a smooth outer surface of the first bearing element.

22. A sliding bearing, comprising:
a first bearing element including:
a first surface;
a coating including:
a vapor deposition inner layer covering the first surface and including an amorphous carbon; and,
an outer layer:
including polytetrafluoroethylene (PTFE); and,
covering the vapor deposition inner layer; and,
a second bearing element including:
a second surface; and,
a layer, including PTFE, glued to the second surface and in contact with the outer layer of the first bearing element.

23. The sliding bearing of claim 22, wherein the amorphous carbon:
includes metallic and non-metallic doping elements; or,
is free of hydrogen.

24. The sliding bearing of claim 22, wherein the vapor deposition inner layer includes:
a metal; or,
at least one hard material selected from the group consisting of nitridic hard materials, carbidic hard materials, and oxidic hard materials; or,
at least one hard material selected from the group consisting of titanium, aluminum, chromium, and molybdenum.

25. The sliding bearing of claim 22, wherein the layer of the second bearing element includes:
a PTFE fiber-reinforced plastic; or,
a PTFE fabric in a resin matrix; or,
a metal-polymer composite material including sintered bronze and PTFE.

26. A method of fabricating a sliding bearing, comprising:
applying, using vapor deposition, an inner layer of a coating to a first surface of a first bearing element;
applying an outer layer, including polytetrafluoroethylene (PTFE), of the coating over the inner layer;
gluing a layer, including PTFE, to a surface of a second bearing element; and,
contacting the outer layer of the coating with the layer of the second bearing element.

27. The method of claim 26, wherein applying, using vapor deposition, the inner layer of the coating to the first surface of the first bearing element includes applying:
an amorphous carbon to the first surface of the first bearing element; or,
a metal to the first surface of the first bearing element; or,
at least one hard material selected from the group consisting of nitridic hard materials, carbidic hard materials, and oxidic hard materials to the first surface of the first bearing element; or,
at least one hard material selected from the group consisting of titanium, aluminum, chromium, and molybdenum to the first surface of the first bearing element.

28. The method of claim 27, wherein:
applying, using vapor deposition, the inner layer of the coating to the first surface of the first bearing element includes applying the amorphous carbon to the first surface of the first bearing element; and,
applying the amorphous carbon to the first surface of the first bearing element includes applying:
at least one doping element to the first surface of the first bearing element; or,
metallic or non-metallic doping elements to the first surface of the first bearing element; or,
the amorphous carbon free of hydrogen to the first surface of the first bearing element.

29. The method of claim 26, wherein gluing the layer including PTFE to the surface of the second bearing element includes gluing:
a PTFE fiber-reinforced plastic to the surface of the second bearing element; or,
a PTFE fabric in a resin matrix to the surface of the second bearing element; or,
a metal-polymer composite material including sintered bronze and PTFE to the surface of the second bearing element.

30. The method of claim 26, wherein applying the outer layer, including PTFE, to the inner layer includes:
filling depressions in the inner layer; and,
forming, with the outer layer, a smooth outer surface of the first bearing element.
